(19) United States
(12) Patent Application Publication
(10) Pub. No.: US 2019/0026365 A1
(43) Pub. Date: Jan. 24, 2019

(54) METHOD AND SYSTEM FOR GENERATING AN ONTOLOGY FOR ONE OR MORE TICKETS

(71) Applicant: WIPRO LIMITED, BANGALORE (IN)

(72) Inventor: Selvakuberan KARUPPASAMY, Chennai (IN)

(73) Assignee: Wipro Limited

(21) Appl. No.: 15/710,945

(22) Filed: Sep. 21, 2017

(30) Foreign Application Priority Data
Jul. 20, 2017 (IN) 201741025765

(51) Int. Cl. G06F 17/30; G06F 17/27; H04L 12/24

(52) U.S. Cl. CPC G06F 17/30734; H04L 41/5074; G06F 17/27

(57) ABSTRACT

The present disclosure relates to method and system for generation an ontology for one or more tickets by an ontology generation system. The ontology generation system comprises receiving Standard Operating Procedures (SOP) from ticket management system, the SOP comprises issue description of each of one or more tickets along with corresponding one or more resolutions. The ontology generation system identifies data properties associated with one or more tickets using natural language processing and text analysis and generate ontology for each of one or more tickets by building relationship between data properties, application name, instance, issue description and one or more resolutions corresponding to each of one or more tickets. The application name and instance associated with each of one or more tickets are identified based on SOP. The present disclosure provides quick response time for user query and saves memory and time.

### TECHNICAL FIELD

The present subject matter is related in general to the field of ticket management system, more particularly, but not exclusively to a method and system for generating an ontology for one or more tickets.

### BACKGROUND

Today, enterprises spend significant amount of time and resources on help desk which caters to either employees or external users of enterprise's services. Out of the incidents which are being raised to the help desk, 5 to 20 percentages of incidents may be resolved by providing information/clarification or self-help processes. Mostly, first level help desk employees address such issues. Generally, every issue which is frequently faced by the users are documented as a Standard Operating Procedure (SOP) which defines the step-by-step approach to resolve the issue. Currently, one of the latest trend in enterprise help desk management is to provide virtual agents and/or automated solutions to incidents wherever applicable. Such system accepts the user query and provides solutions based on issue description given by the users.

In existing systems, to virtualize the first level helpdesk, the user query must be classified into correct issue category accurately. Pre-defined issue categorizations of incident management systems are usually not fine-grained, hence defining issue hierarchy or taxonomy or ontology needs to be done from initial stage in the existing systems. Defining the issue hierarchy or ontology from scratch requires a huge amount of manual work to identify the various issues under different applications, their symptoms, and corresponding solution. Enterprise helpdesk tickets history might provide valuable inputs in identifying the top problems and their symptoms. This can in turn be converted into issue ontology. However, the volume of tickets is usually very high for manual inspection of tickets and for deriving required information. Thus, a solution is required to mine the ticket data to identify problems, symptoms and provide inputs for creation of issue ontology in semi-automatic manner.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure relates to a method for generating an ontology for one or more tickets. The method may comprise receiving Standard Operating Procedures (SOP) from a ticket management system. The SOP comprises issue description of each of the one or more tickets along with corresponding one or more resolutions. The method comprises identifying data properties associated with the one or more tickets using natural language processing and text analysis, identifying an application name and an instance associated with each of the one or more tickets based on the SOP and generating an ontology for each of the one or more tickets by building a relationship between the application name, the instance, the issue description and the one or more resolutions corresponding to each of the one or more tickets.

In an embodiment, the present disclosure relates to an ontology generation system for generating an ontology for one or more tickets. The ontology generation system comprises a processor and a memory communicatively coupled to the processor, where the memory stores processor executable instructions, which, on execution, may cause the ontology generation system to receive Standard Operating Procedures (SOP) from a ticket management system. The SOP comprises issue description of each of the one or more tickets along with corresponding one or more resolutions. The ontology generation system identifies data properties associated with the one or more tickets using natural language processing and text analysis, identifies an application name and an instance associated with each of the one or more tickets based on the SOP and generates an ontology for each of the one or more tickets by building a relationship between the application name, the instance, the issue description and the one or more resolutions corresponding to each of the one or more tickets.

In an embodiment, the present disclosure relates to a non-transitory computer readable medium including instructions stored thereon that when processed by at least one processor may cause an ontology generation system to receive Standard Operating Procedures (SOP) from a ticket management system. The SOP comprises issue description of each of the one or more tickets along with corresponding one or more resolutions. The instructions causes the processor to identify data properties associated with the one or more tickets using natural language processing and text analysis, identify an application name and an instance associated with each of the one or more tickets based on the SOP and generate an ontology for each of the one or more tickets by building a relationship between the application name, the instance, the issue description and the one or more resolutions corresponding to each of the one or more tickets.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary environment for generating an ontology for one or more tickets in accordance with some embodiments of the present disclosure;

FIG. 2 shows a detailed block diagram of an ontology generation system in accordance with some embodiments of the present disclosure;

FIG. 3a illustrates a flowchart showing a method for generating an ontology for one or more tickets in accordance with some embodiments of present disclosure;

FIG. 3b illustrates a flowchart showing a method for generating an ontology for a user query in accordance with some embodiments of present disclosure;

FIG. 4 shows an exemplary representation of ticket management system for generating an ontology for a user query in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates to a method and an ontology generation system for generating an ontology for one or more tickets. In an embodiment, the ontology may refer to an explicit formal specification of terms of a domain and relation between them. Initially, the ontology generation system may generate an ontology for one or more tickets present in Standard Operating Procedures (SOP) of a ticket management system. The ontology generation system may receive the SOP from the ticket management system of an enterprise. In an embodiment, the SOP may include issue description and one or more resolutions associated with the one or more tickets raised to the ticket management system. The one or more tickets in the SOP may be analysed to identify data properties associated with the one or more tickets using natural language processing and text analysing. In an embodiment, the data properties may be identified by extracting Parts of Speech (POS) from the one or more tickets. Based on the SOP, the ontology generation system may identify an application name and an instance associated with the one or more tickets. The ontology generation system may generate an ontology for the one or more tickets by building a relationship between the application name, the instance, the issue description and the one or more resolutions corresponding to the one or more tickets. In an embodiment, the ontology generation system may determine an ontology for a user query associated with a current ticket based on the generated ontology and one or more follow-up questions to user. The ontology generation system provides a quick response time to users for queries based on the generated ontology and provides a continuous learning environment for training the ontology for new user queries.

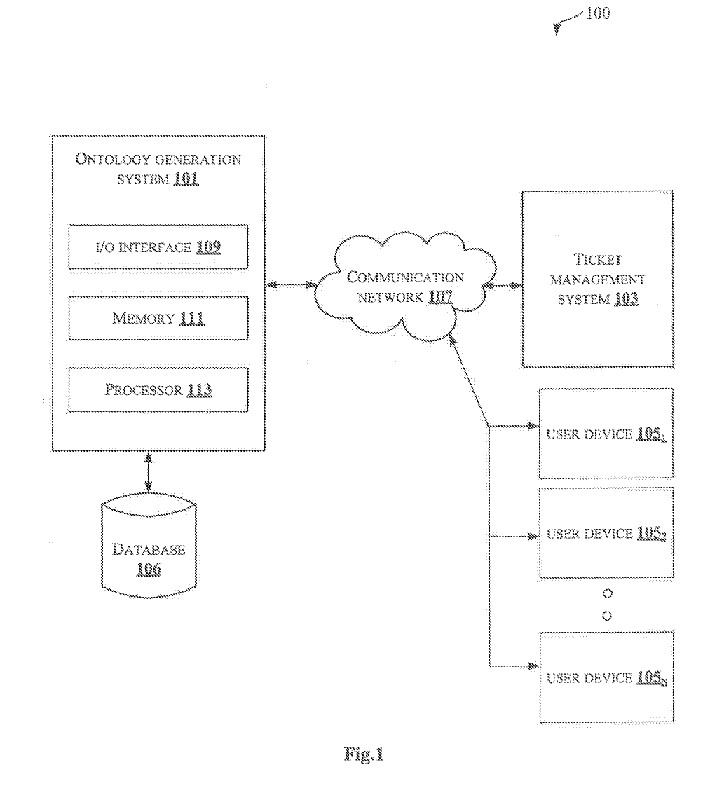

FIG. 1 illustrates an exemplary environment for generating an ontology for one or more tickets in accordance with some embodiments of the present disclosure.

As shown in FIG. 1, the environment 100 includes an ontology generation system 101 connected through a communication network 107 to a ticket management system 103 of an enterprise, and a user device 105₁, a user device 105₂ . . . and a user device 105_{N} (collectively referred as plurality of user devices 105). The communication network 107 may include, but is not limited to, a direct interconnection, an e-commerce network, a Peer to Peer (P2P) network, Local Area Network (LAN), Wide Area Network (WAN), wireless network (e.g., using Wireless Application Protocol), Internet, Wi-Fi and the like. Further, the ontology generation system 101 may be connected to a database 106. The ontology generation system 101 may generate an ontology for one or more tickets based on Standard Operating Procedures (SOP) of the ticket management system 103. The ontology generated by the ontology generation system 101 may be stored in the database 106. In an embodiment, the ontology generation system 101 may include, but is not limited to, a laptop, a desktop computer, a Personal Digital Assistant (PDA), a notebook, a smartphone, a tablet, a server and any other computing devices. A person skilled in the art would understand that, any other devices, not mentioned explicitly, may also be used in the present disclosure.

Initially, the ontology generation system 101 may receive the SOP from the ticket management system 103. In an embodiment, the SOP includes issue description of the one or more tickets and one or more resolutions associated with the one or more tickets raised on the ticket management system 103. In an embodiment, the issue description may be represented as annotations in the ticket management system 103. On receiving the SOP, the ontology generation system 101 may identify data properties associated with the one or more tickets. The data properties may be identified by using Natural Language Processing (NLP) and text analysis. A person skilled in the art would understand that any other technique, not mentioned explicitly, may also be used for identifying the data properties associated with the one or more tickets. In an embodiment, the data properties may be identified by extracting Parts of Speech (POS) from the one or more tickets. For example, the POS may include nouns, pronouns, verb and the like. In an embodiment, the POS enables identification of problem description associated with the one or more tickets. Further, in addition to the data properties, the ontology generation system 101 may identify an application name and an instance associated with the one or more tickets based on the SOP. The ontology generation system 101 may generate the ontology for the one or more tickets by building a relationship between the data properties, the issue description, the one or more resolutions, the application name and the instance corresponding to the one or more tickets. In an embodiment, the ontology generation system 101 may receive a user query associated with a current ticket from a user device of the plurality of user devices 105. In an embodiment, the user query received from the user device may be in at least one of speech format and text format. On receiving the user query, the ontology generation system 101 may extract data properties associated with the user query and maps with the issue description of each of the one or more tickets provided in the generated ontology. Based on the mapping, the ontology generation system 101 may identify one or more resolutions for the user query. In an embodiment, if the one or more resolutions are not identified, the ontology generation system 101 may provide one or more follow-up questions for the user query. In an embodiment, the ontology generation system 101 trains the ontology based on responses for the one or more follow-up questions received from the user through the plurality of user devices 105.

The ontology generation system 101 includes an I/O Interface 109, a memory 111 and a processor 113. The I/O interface 109 may be configured to receive the SOP from the ticket management system 103. The I/O interface 109 may also receive the user query from the plurality of user devices 105.

The received information from the I/O interfaces 109 may be stored in the memory 111. The memory 111 is communicatively coupled to the processor 113 of the ontology generation system 101. The memory 111 may also store processor instructions which may cause the processor 113 to execute the instructions for generating the ontology for the one or more tickets.

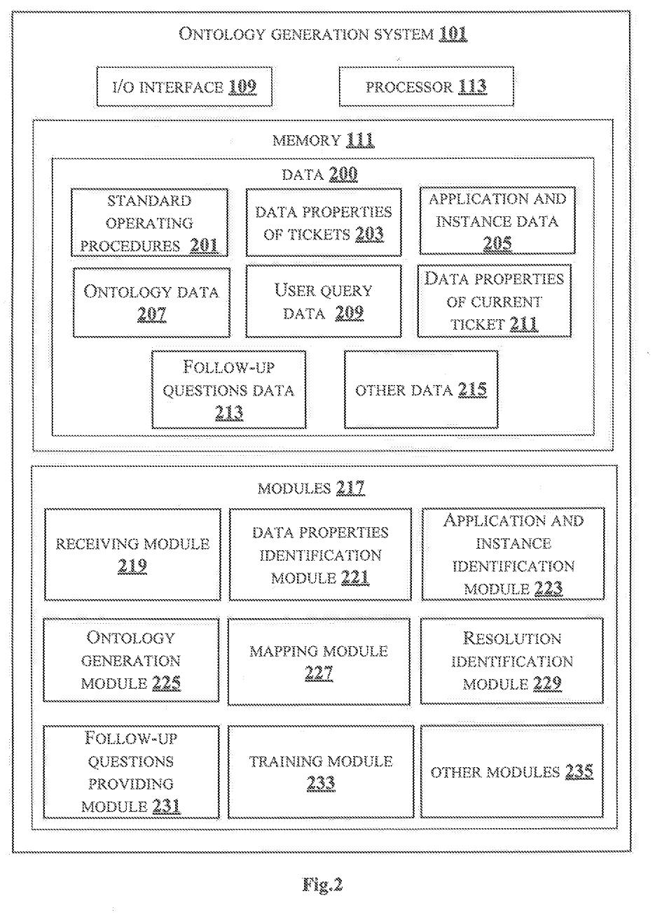

FIG. 2 shows a detailed block diagram of an ontology generation system in accordance with some embodiments of the present disclosure.

Data 200 and one or more modules 217 of the ontology generation system 101 are described herein in detail. In an embodiment, the data 200 includes standard operating procedures 201, data properties of tickets 203, application and instance data 205, ontology data 207, user query data 209, data properties of current ticket 211, follow-up questions data 213 and other data 215.

The Standard Operating Procedures (SOP) 201 may include issue description for the one or more tickets which are raised to the ticket management system 103 along with the corresponding one or more resolutions. For example, the issue description associated with a ticket may be unable to login, access denied, cannot login and the like. The SOP 201 may include resolutions in a step by step approach. For example, if the issue description is “unable to login”, the SOP 201 may include three steps to resolve the issue. The first step may be “check whether the user has access to login”, the second step may be “If yes, check the browser settings and proxy configuration” and the third step is “if no, do the necessary steps to get the access to login”.

The data properties of tickets 203 may include the Parts of Speech (POS) associated with the one or more tickets. The POS may include, but are not limited to, verbs, pronouns, adjectives, adverbs and the like. The POS may further enable identifying problem description associated with the one or more tickets. In an embodiment, the data properties of tickets 203 may be identified using NLP and text analysis techniques.

The application and instance data 205 may include the application name and the instance identified for each of the one or more tickets. The application name and the instance is identified based on the SOP 201. As an example, let the application name be Browsapp. The Browsapp application may comprise the issues description including, but not limited to, browser issue, login issue and account issue. Also, for the issue description associated with the one or more tickets, the instance may be identified. For example, for the browser issue, the instance identified may be Chrome, Mozilla, Firefox and the like.

The ontology data 207 may include the ontology generated for the one or more tickets. The ontology may be generated based on the relationship between the data properties, the issue description, the instance and the corresponding resolutions corresponding to the one or more tickets from the SOP 201.

The user query data 209 may include the queries from the plurality of user devices 105. The user query is associated with the current ticket. In an embodiment, the user may raise the current ticket to the ticket management system 103 for resolution.

The data properties of current ticket 211 may include the POS related to the current ticket. The data properties of the current ticket 211 may be used for mapping and identifying the ontology for the current ticket. The data properties of current ticket 211 may be identified using NLP and text analysis technique.

The follow-up questions data 213 may include follow-up questions to be provided to the user. The follow-up questions may be provided to the user if the one or more resolutions for the user query are not identified.

The other data 215 may store data, including temporary data and temporary files, generated by modules 217 for performing the various functions of the ontology generation system 101.

In an embodiment, the data 200 in the memory 111 are processed by the one or more modules 217 of the ontology generation system 101. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. The said modules 217 when configured with the functionality defined in the present disclosure will result in a novel hardware.

In one implementation, the one or more modules 217 may include, but are not limited to, a receiving module 219, a data properties identification module 221, an application and instance identification module 223, an ontology generation module 225, a mapping module 227, a resolution identification module 229, follow-up questions providing module 231 and a training module 233. The one or more modules 217 may also comprise other modules 235 to perform various miscellaneous functionalities of the ontology generation system 101. It will be appreciated that such modules 217 may be represented as a single module or a combination of different modules 217.

The receiving module 219 may receive the SOP 201 from the ticket management system 103. The SOP 201 may include the issue description and corresponding one or more resolution for each of the one or more tickets raised on the ticket management system 103. Further, the receiving module 219 may receive the user query for the current ticket from the plurality of user devices 105.

The data properties identification module 221 may identify the data properties associated with the one or more tickets. The data properties identification module 221 may also identify the data properties associated with the user query. In an embodiment, the user query received from the plurality of user devices 105 may be in at least one of speech format and text format. The data properties identification module 221 may identify the data properties by extracting Parts of Speech (POS) from the one or more tickets and the current ticket. Further, the data properties identification module 221 may also enable identifying problem description associated with each of the one or more tickets and the current ticket. In an embodiment, the data properties identification module 221 uses NLP and text analysis techniques to identify the POS for the one or more tickets and the current ticket. The NLP technique may be applied to both speech and text. For example, with respect to email prioritization, the NLP technique may include, sentence detection, tokenization, sentence tagging, POS tagging, named entity recognition, co-reference resolution and the like. In an embodiment, the text analysis technique may scan the user query. The text analysis technique may perform iterative level of classification to identify the problem from the user utterances. In an embodiment, the text analysis technique may neglect unwanted words, junk and unimportant text from the user query. In an embodiment, the data properties may refer to relationship between any two subjects. For example, consider a browser, the browser has 3.1 as version.

The application and instance identification module 223 may identify the application name and the instance associated with the one or more tickets. The application and instance identification module 223 may identify the application name and the instance based on the SOP 201. In an embodiment, the SOP 201 contains the step by step instructions to resolve instances. The instance may be entities or subjects related to the particular issue. The subject-predicate-object relationship may be identified based on the structure of the relationship designed in the ontology.

The ontology generation module 225 may generate the ontology for the one or more tickets. The ontology generation module 225 may generate the ontology by building the relationship between the issue description and the corresponding one or more resolutions, the data properties, the application name and the instance related to the one or more tickets.

The mapping module 227 may map the data properties identified for the current ticket with the issue description of the one or more tickets present in the generated ontology. In an embodiment, the data properties are mapped word by word to identify similarity between the current ticket and the one or more tickets in the generated ontology.

The resolution identification module 229 may identify one or more resolutions based on the mapping for the user query associated with the current ticket. The resolution identification module 229 may identify the one or more resolutions from the mapped data properties of the current ticket and the issue description of the ticket, with which the current data properties of the current ticket mapped. In an embodiment, the one or more resolutions of the user query may be the one or more resolutions of the ticket with which the data properties of the current ticket are mapped.

The follow-up questions providing module 231 may provide one or more follow-up questions associated with the user query to the user. In an embodiment, the follow-up questions providing module 231 may provide the one or more follow-up questions for the user query in case the one or more resolutions are not identified during the mapping.

The training module 233 may train the generated ontology based on responses for the one or more follow-up questions received from a user through the plurality of user devices 105. The training module 233 may capture the responses and learn incrementally to aid the actual learning of the generated ontology. In an embodiment, based on the training, the ontology may be generated for the user query.

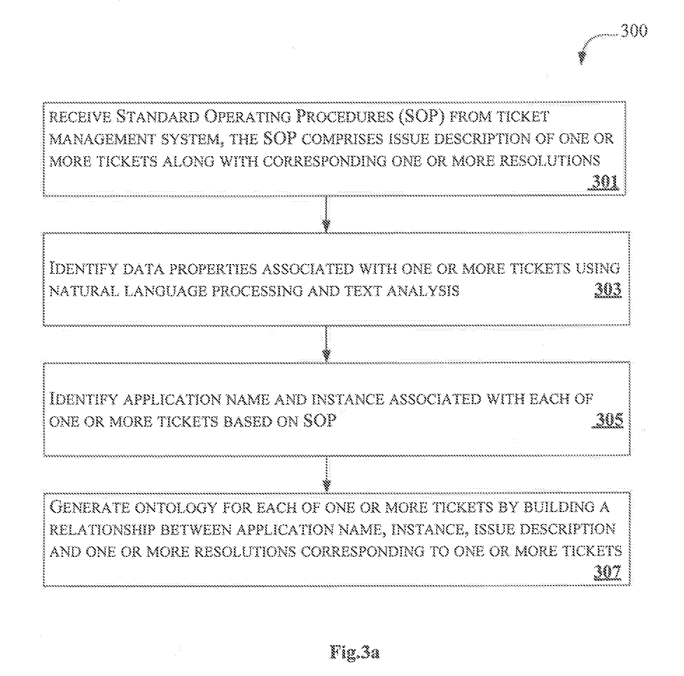

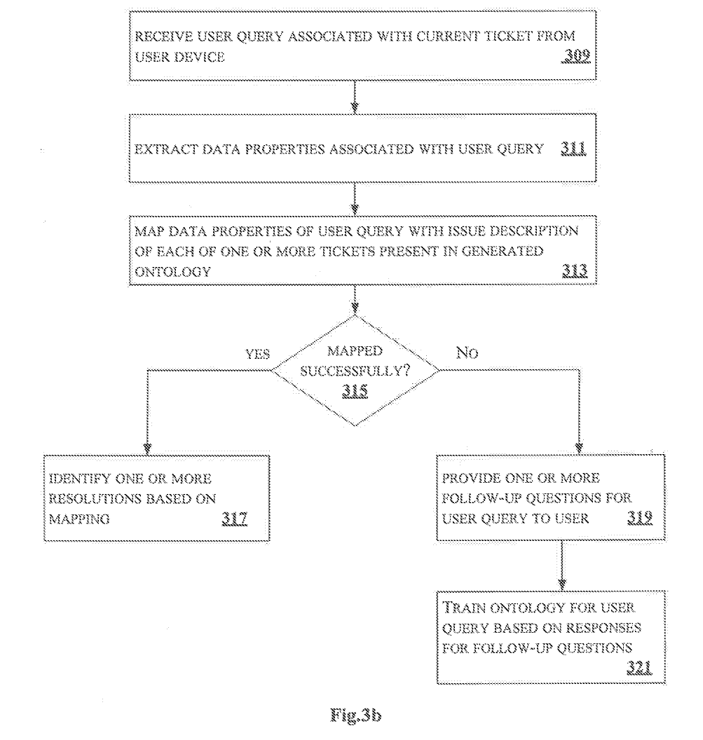

FIG. 3a illustrates a flowchart showing a method for generating an ontology for one or more tickets in accordance with some embodiments of present disclosure.

As illustrated in FIG. 3a, the method 300 includes one or more blocks for generating an ontology for one or more tickets. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, receiving, by the receiving module 219, the SOP 201 from the ticket management system 103. The SOP 201 includes the issue description and the one or more resolutions associated with the one or more tickets. In an embodiment, the SOP 201 may be created in the ticket management system 103.

At block 303, identifying, by the data properties identification module 221, the data properties associated with the one or more tickets using the NLP and text analysis technique. In an embodiment, the data properties of the one or more tickets in the SOP 201 are identified by extracting POS from the one or more tickets.

At block 305, identifying, by the application and instance identification module 223, the application name and the instance associated with the one or more tickets based on the SOP 201.

At block 307, generating, by the ontology generation module 225, the ontology for the one or more tickets by building the relationship between the data properties, the application name, the instance, the issue description and the one or more resolutions associated with the one or more tickets.

FIG. 3b illustrates a flowchart showing a method for generating an ontology for a user query in accordance with some embodiments of present disclosure.

As illustrated in FIG. 3b, the method includes one or more blocks for generating an ontology for the user query associated with the current ticket. The method may be described in the general context of computer executable instructions. Generally, computer executable instructions can include routines, programs, objects, components, data structures, procedures, modules, and functions, which perform particular functions or implement particular abstract data types.

At block 309, receiving, by the receiving module 219, the user query associated with the current ticket from the user device of the plurality of user devices 105. In an embodiment, the user query received from the user device may be least one of speech format and text format.

At block 311, extracting, by the data properties identification module 221, the data properties associated with the current ticket using the NLP and text analysis technique.

At block 313, mapping, by the mapping module 227, the data properties of the user query with the issue description of the one or more tickets present in the generated ontology.

At block 315, checking, by the mapping module 227, if the mapping of the data properties and the issue description of the one or more tickets is successful. If the mapping is successful, the method moves to block 317. Alternatively, the method moves to block 319.

At block 317, identifying, by the resolution identification module 229, one or more resolutions for the user query based on the mapping. The one or more resolutions of the user query are the one or more resolution of the ticket which with the data properties of the user query mapped.

At block 319, providing, by the follow-up questions providing module 231, the one or more follow-up questions for the user query to the user through the user device when the mapping is unsuccessful.

At block 321, training, by the training module 233, the ontology for the user query based on responses for the follow-up questions from the user.

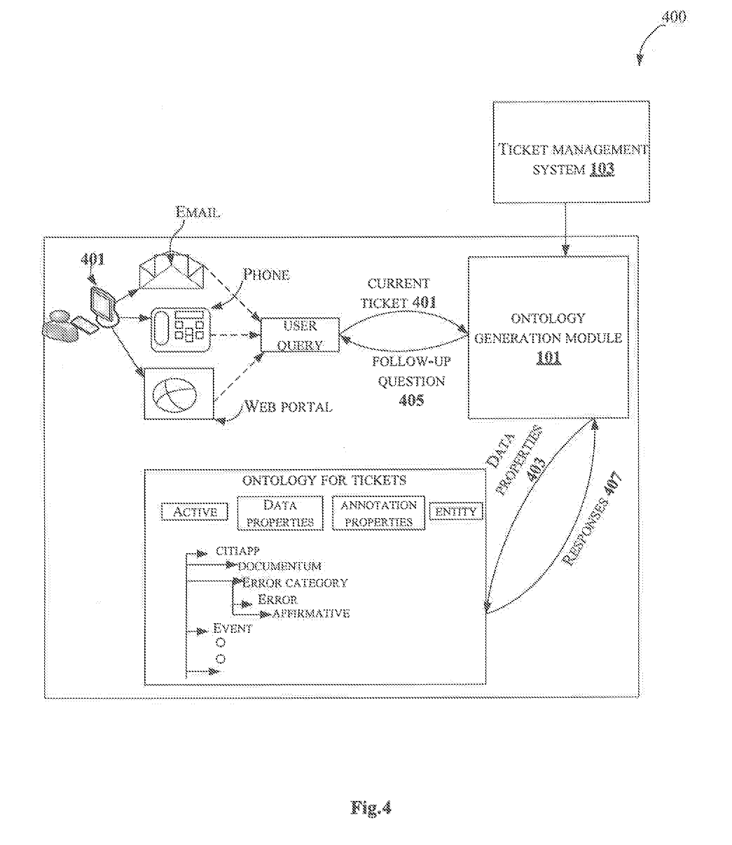

FIG. 4 shows an exemplary representation of ticket management system for generating an ontology for a user query in accordance with some embodiments of the present disclosure.

As shown in FIG. 4, the environment 400 illustrates a scenario of generating an ontology for a user query in an exemplary embodiment of the present disclosure. The environment 400 includes the ontology generation system 101 which may be connected to the ticket management system 103. The ontology generation system 101 is connected to a user device 105₁. A person skilled in the art would understand that FIG. 4 is an exemplary embodiment, and the ontology generation system 101 may be connected with the plurality of user devices 105. In an embodiment, the user device 105₁ shown in the FIG. 4 is an exemplary device and the present disclosure may include any other type of user device. As shown in FIG. 4, the user may send queries either through an email, by a phone call or by a web portal. A person skilled in the art would understand that FIG. 4 is an exemplary embodiment, and the user may send the queries in any other form. In an embodiment, the user device 105₁ may be connected through the communication network (not shown in FIG. 4) to the ontology generation system 101. Further, the environment 400 comprises an ontology generated for the one or more tickets of the ticket management system 103. Initially, at 401, the ontology generation system 101 may receive a user query in any of the form such as, email, voice speech and through web portal from the user device 105₁. On receiving the user query from the user device 105₁, at step 403, the ontology generation system 101 identifies the data properties associated with the user query. Further, the data properties of the user query are mapped with the issue description of the one or more tickets in the ontology which is generated and stored in the ontology generation system 101. In case, while mapping the data properties, if the resolutions for the user query are not identified, then at block 405, the ontology generation system 101 may provide one or more follow-up questions to the user through the user device 105₁. The user may provide responses for the one or more follow-up questions to the ontology generation system 101. At step 407, the ontology generation system 101 identifies the resolutions for the user query and learns the ontology for the user query based on the responses.

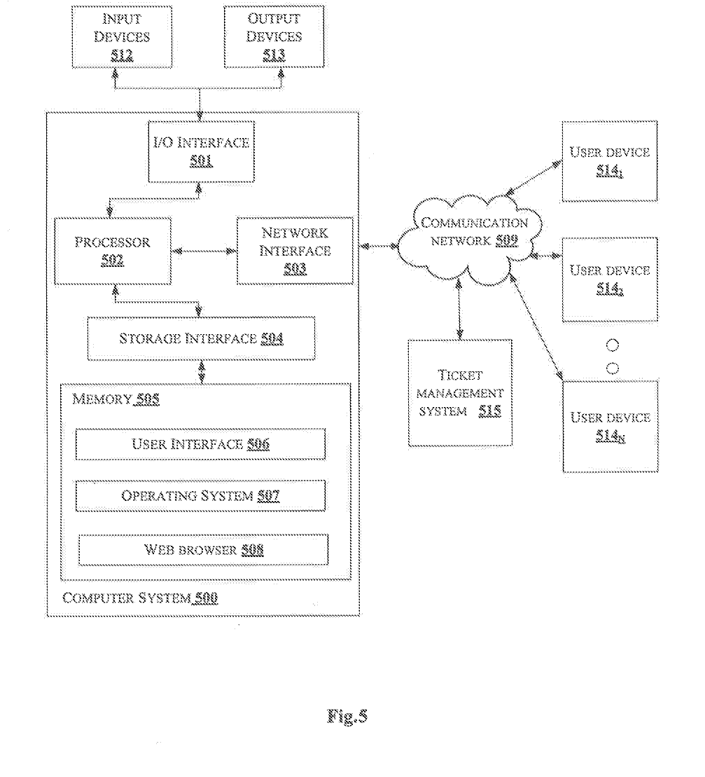

FIG. 5 illustrates a block diagram of an exemplary computer system 500 for implementing embodiments consistent with the present disclosure. In an embodiment, the computer system 500 is used to implement the ontology generation system 101. The computer system 500 may comprise a central processing unit (“CPU” or “processor”) 502. The processor 502 may comprise at least one data processor for generating an ontology for one or more tickets. The processor 502 may include specialized processing units such as, integrated system (bus) controllers, memory management control units, floating point units, graphics processing units, digital signal processing units, etc.

The processor 502 may be disposed in communication with one or more input/output (I/O) devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices. For example, the input device may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 500 consists of an ontology generation system 101. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, local area network (LAN), wide area network (WAN), wireless network (e.g., using Wireless Application Protocol), the Internet, etc. Using the network interface 503 and the communication network 509, the computer system 500 may communicate with a user device 514₁, a user device 514₂, . . . and a user device 514_{N} (collectively referred as plurality of user device 514) and a ticket management system 515. The network interface 503 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 509 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., RAM, ROM, etc. not shown in FIG. 5) via a storage interface 504. The storage interface 504 may connect to memory 505 including, without limitation, memory drives, removable disc drives, etc., employing connection protocols such as, serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data 506, such as, the data, variables, records, etc., as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The present disclosure helps in generating an ontology for a current user query in real-time.

An embodiment of the present disclosure provides quick response time for tickets raised by user in real-time.

An embodiment of the present disclosure preserves memory by eliminating need for databases for each and every new user query.

An embodiment of the present disclosure preserves time by providing quick response time for user query based on self-learning and previously generated ontology.

An embodiment of the present disclosure provides a continuous self-learning approach for learning and training the ontology.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as, an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 3 and 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Ontology generation system |
| 103 | Ticket management system |
| 105 | Plurality of user devices |
| 107 | Communication network |
| 109 | I/O interface |
| 111 | Memory |
| 113 | Processor |
| 200 | Data |
| 201 | Standard Operating Procedures (SOP) |
| 203 | Data properties of tickets |
| 205 | Application and instance data |
| 207 | Ontology data |
| 209 | User query data |
| 211 | Data properties of current ticket |
| 213 | Follow-up questions data |
| 215 | Other data |
| 217 | Modules |
| 219 | Receiving module |
| 221 | Data properties identification module |
| 223 | Application and instance identification module |
| 225 | Ontology generation module |
| 227 | Mapping module |
| 229 | Resolution identification module |
| 231 | Follow-up questions providing module |
| 233 | Training module |
| 235 | Other modules |

What is claimed is:

1. A method for generating an ontology for one or more tickets, the method comprising:
receiving, by an ontology generation system, Standard Operating Procedures (SOP) from a ticket management system, wherein the SOP comprises issue description of each of the one or more tickets along with corresponding one or more resolutions;
identifying, by the ontology generation system, data properties associated with the one or more tickets using natural language processing and text analysis; and
generating, by the ontology generation system, an ontology for each of the one or more tickets by building a relationship between the data properties, an application name, an instance, the issue description and the one or more resolutions corresponding to each of the one or more tickets, wherein the application name and the instance associated with each of the one or more tickets are identified based on the SOP.

2. The method as claimed in claim 1 further comprising:
receiving, by the ontology generation system, a user query, associated with a current ticket from a user device;
extracting, by the ontology generation system, data properties associated with the user query;
mapping, by the ontology generation system, the data properties of the user query with the issue description of each of the one or more tickets provided in the generated ontology; and
identifying, by the ontology generation system, one or more resolutions for the user query based on the mapping.

3. The method as claimed in claim 2, wherein the user query received from the user device is in at least one of speech format and text format.

4. The method as claimed in claim 1, wherein identifying the data properties of the one or more tickets in the SOP and the data properties of the current ticket comprises extracting Parts of Speech (POS) from the one or more tickets and the current ticket, further wherein the POS enables identifying problem description.

5. The method as claimed in claim 2 further comprising providing one or more follow-up questions for the user query, if the one or more resolutions are unidentified based on the mapping.

6. The method as claimed in claim 5 further comprising training the ontology based on responses for the one or more follow-up questions received from a user through the user device.

7. The method a claimed in claim 1, wherein the issue description is represented as annotations in the ticket management system.

8. An ontology generation system for generating an ontology for one or more tickets, comprising:
a processor; and
a memory communicatively coupled to the processor, wherein the memory stores processor instructions, which, on execution, causes the processor to:
receive Standard Operating Procedures (SOP) from a ticket management system, wherein the SOP comprises issue description of each of the one or more tickets along with corresponding one or more resolutions;
identify data properties associated with the one or more tickets using natural language processing and text analysis; and
generate an ontology for each of the one or more tickets by building a relationship between the data properties, an application name, an instance, the issue description and the one or more resolutions corresponding to each of the one or more tickets, wherein the application name and the instance associated with each of the one or more tickets are identified based on the SOP.

9. The ontology generation system as claimed in claim 8 further comprises:
receiving a user query, associated with a current ticket from a user device;
extracting data properties associated with the user query;
mapping the data properties of the user query with the issue description of each of the one or more tickets provided in the generated ontology; and
identifying one or more resolutions for the user query based on the mapping.

10. The ontology generation system as claimed in claim 9, wherein the user query received from the user device is in at least one of speech format and text format.

11. The ontology generation system as claimed in claim 8, wherein identifying the data properties of the one or more tickets in the SOP and the data properties of the current ticket comprises extracting Parts of Speech (POS) from the one or more tickets and the current ticket, further wherein the POS enables identifying problem description.

12. The ontology generation system as claimed in claim 9, wherein the processor provides one or more follow-up questions for the user query, if the one or more resolutions are unidentified based on the mapping.

13. The ontology generation system as claimed in claim 12, wherein the processor trains the ontology based on responses for the one or more follow-up questions received from a user through the user device.

14. The ontology generation system a claimed in claim 8, wherein the processor represents the issue description as annotations in the ticket management system.

15. A non-transitory computer readable medium including instruction stored thereon that when processed by at least one processor cause an ontology generation system to perform operation comprising:
receiving Standard Operating Procedures (SOP) from a ticket management system, wherein the SOP comprises issue description of each of the one or more tickets along with corresponding one or more resolutions;
identifying data properties associated with the one or more tickets using natural language processing and text analysis; and
generating an ontology for each of the one or more tickets by building a relationship between the data properties, an application name, an instance, the issue description and the one or more resolutions corresponding to each of the one or more tickets, wherein the application name and the instance associated with each of the one or more tickets are identified based on the SOP.

16. The medium as claimed in claim 15 further comprising:
receiving, by the ontology generation system, a user query, associated with a current ticket from a user device;
extracting, by the ontology generation system, data properties associated with the user query;
mapping, by the ontology generation system, the data properties of the user query with the issue description of each of the one or more tickets provided in the generated ontology; and
identifying, by the ontology generation system, one or more resolutions for the user query based on the mapping.

17. The medium as claimed in claim 16, wherein the user query received from the user device is in at least one of speech format and text format.

18. The medium as claimed in claim 15, wherein identifying the data properties of the one or more tickets in the SOP and the data properties of the current ticket comprises extracting Parts of Speech (POS) from the one or more tickets and the current ticket, further wherein the POS enables identifying problem description.

19. The medium as claimed in claim 16, wherein the instruction causes the processor to provide one or more follow-up questions for the user query, if the one or more resolutions are unidentified based on the mapping.

20. The medium as claimed in claim 19, wherein the instruction causes the processor to train the ontology based on responses for the one or more follow-up questions received from a user through the user device.

21. The medium a claimed in claim 15, wherein the issue description is represented as annotations in the ticket management system.
